(19) United States
(12) Patent Application Publication
(10) Pub. No.: US 2021/0131591 A1
(43) Pub. Date: May 6, 2021

(54) Flow Path Member, Flow Path Unit, And Liquid Ejecting Apparatus

(71) Applicant: Seiko Epson Corporation, Tokyo (JP)

(72) Inventors: Hiroyuki KOBAYASHI, Azumino (JP); Hiroshige OWAKI, Okaya (JP)

(21) Appl. No.: 17/084,802

(22) Filed: Oct. 30, 2020

(30) Foreign Application Priority Data
Oct. 31, 2019 (JP) 2019-198529

(51) Int. Cl. F16L 21/00; F16L 21/02; B41J 2/135; B41J 2/175

(52) U.S. Cl. CPC F16L 21/005; B41J 2/175; B41J 2/135; F16L 21/02

(57) ABSTRACT

A flow path member coupled to a pipe including a first-flow path includes a coupling member including a coupling surface provided with a recessed portion that the pipe is inserted and a second-flow path communicating with the first-flow path and an opening provided in a bottom surface of the recessed portion, and an elastic member that is inserted into the recessed portion and is provided with a through hole that the pipe is inserted. The elastic member includes a first-seal portion being in contact with the pipe and a second-seal portion being provided apart from the bottom surface and being in contact with the coupling member. Between the second-seal portion and the bottom surface, a gap is provided between an outer circumferential surface of the elastic member and an inner circumferential surface of the recessed portion, and the gap communicates with the second-flow path.

The present application is based on, and claims priority from JP Application Serial Number 2019-198529, filed Oct. 31, 2019, the disclosure of which is hereby incorporated by reference herein in its entirety.

### BACKGROUND

### 1. Technical Field

The present disclosure relates to a flow path member, a flow path unit, and a liquid ejecting apparatus.

### 2. Related Art

Regarding a flow path member that is provided in a device such as an ink jet printer and that causes a liquid such as ink to flow inside the device, for example, in JP-A-2016-41519, there is disclosed a flow path member provided with an elastic biasing member which biases and holds a liquid supply pipe including a flow path that supplies a fluid, a holder that holds the elastic biasing member, and a fixing member that interposes the elastic biasing member between the fixing member and the inner wall of the holder.

In the flow path member of JP-A-2016-41519, even when a pressure inside the flow path formed in the holder increases due to the elastic biasing member being interposed between the fixing member and the inner wall of the holder, the sealing performance between the elastic biasing member and the holder is ensured. However, the inventors discovered that the sealing performance may not be sufficiently ensured between the liquid supply pipe and the elastic biasing member and liquid may leak.

### SUMMARY

According to an aspect of the present disclosure, there is provided a flow path member. The flow path member is coupled to a pipe including a first flow path inside the pipe, the flow path member including a coupling member including a coupling surface that is a surface intersecting an extending direction in which the first flow path extends and that is provided with a recessed portion into which the pipe is inserted and a second flow path that communicates with the first flow path and communicates with an opening provided in a bottom surface of the recessed portion, and an elastic member that is inserted into the recessed portion of the coupling member and is provided with a through hole into which the pipe is inserted, in which the elastic member includes a first seal portion being in contact with an outer circumferential surface of the pipe on an inner circumferential surface of the through hole and a second seal portion being provided apart from the bottom surface in the extending direction and being in contact with the coupling member, between the second seal portion and the bottom surface, a gap is provided between an outer circumferential surface of a portion of the elastic member inserted into the recessed portion and an inner circumferential surface of the recessed portion, and the gap communicates with the second flow path.

### BRIEF DESCRIPTION OF THE DRAWINGS

FIG. 1 is an explanatory diagram illustrating a schematic configuration of a liquid ejecting apparatus.

FIG. 2 is an external perspective view of a head unit.

FIG. 3 is a sectional diagram illustrating a schematic configuration of a valve mechanism and a flow path member.

FIG. 4 is a sectional diagram illustrating the schematic configuration of the valve mechanism and the flow path member.

FIG. 5 is an exploded perspective view illustrating a configuration of the flow path member provided in the valve mechanism.

FIG. 6 is a sectional diagram illustrating a configuration of the flow path member in the present embodiment.

FIG. 7 is a sectional diagram taken along line VII-VII illustrating a bottom surface of a recessed portion of a coupling member.

FIG. 8 is an explanatory diagram illustrating a state in which an ink inside the flow path member flows into a gap.

FIG. 9 is a sectional diagram illustrating a configuration of a flow path member according to a second embodiment.

FIG. 10 is a sectional diagram taken along line X-X illustrating a bottom surface of a recessed portion of a coupling member.

FIG. 11 is a sectional diagram illustrating a configuration of a flow path member according to a third embodiment.

FIG. 12 is a sectional diagram illustrating a configuration of a flow path member according to a fourth embodiment.

FIG. 13 is a sectional diagram illustrating a configuration of a flow path member as another embodiment including first grooves.

FIG. 14 is a sectional diagram illustrating the configuration of a flow path member as another embodiment including second grooves.

FIG. 15 is a sectional diagram illustrating a configuration of a flow path member as another embodiment including first grooves and third grooves.

FIG. 16 is a sectional diagram illustrating a configuration of a flow path member as another embodiment including second grooves and fourth grooves.

FIG. 17 is a sectional diagram illustrating a configuration of a flow path member having a fixing member in an annular shape.

### DESCRIPTION OF EXEMPLARY EMBODIMENTS

### A. First Embodiment

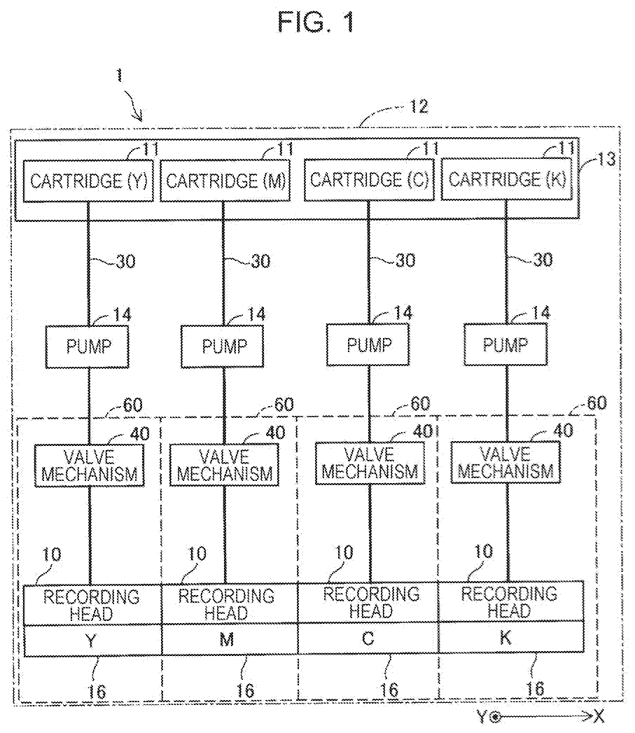

FIG. 1 is an explanatory diagram illustrating a schematic configuration of a liquid ejecting apparatus 1 of the present embodiment. The liquid ejecting apparatus 1 is configured as an ink jet printer that prints an image on a print medium by ejecting an ink as a liquid. The liquid ejecting apparatus 1 is provided with a plurality of cartridges 11 storing a liquid, a plurality of recording heads 10, and a plurality of liquid flow paths 30 that supply the liquid from each of the cartridges 11 to a corresponding one of the recording heads 10. An X direction illustrated in FIG. 1 is a direction in which the plurality of recording heads 10 is arranged in a horizontal direction. The recording medium is transported in a Y direction perpendicular to the X direction in the horizontal direction by a transport mechanism (not illustrated). In addition to paper, the recording medium may be any material capable of holding a liquid, for example, plastic, film, fiber, cloth, leather, metal, glass, wood, ceramic.

The liquid ejecting apparatus 1 is provided with four cartridges 11. Each of the cartridges 11 stores a different type of ink and is mounted in a cartridge mounting section 13 inside a casing 12 of the liquid ejecting apparatus 1. In the present embodiment, the liquid ejecting apparatus 1 is a so-called off-carriage type printer, and the cartridge mounting section 13 is provided at a different part from a carriage (not illustrated). In the present embodiment, “the type of the ink” means the color of the ink, and the cartridge 11 stores four color inks of yellow, magenta, cyan, and black, respectively. The colors of the inks stored in the cartridges 11 are not limited to yellow, magenta, cyan, and black, and may be any other colors such as light cyan, light magenta, red, blue, green, white, and transparent. The “types of the ink” may include types of coloring materials such as dyes and pigments. Each of the cartridges 11 is coupled to a liquid flow path 30 provided for each of the cartridges 11. As the container for storing the ink, for example, an ink tank having a filling port through which it is possible to add the ink from an ink bottle may be provided instead of the cartridge 11. A member that stores the ink, such as the cartridge 11 or an ink tank, may be referred to as a “liquid reservoir”.

The liquid flow path 30 is a flow path for supplying the ink from the cartridge 11 to the recording head 10. The liquid flow path 30 is configured from, for example, a flexible hollow tube, a flow path structure configured by laminating substrates such as resin and metal, and a pipe, a flow path needle, or the like provided at the distal end of the tube. In the liquid flow path 30, a plurality of pumps 14 and a plurality of valve mechanisms 40 are sequentially provided from the upstream cartridge 11 to the downstream recording head 10. A plurality of the pumps 14 and the valve mechanisms 40 is provided corresponding to each of the recording heads 10.

Each of the pumps 14 sucks ink from the cartridge 11, pressurizes the sucked ink, and supplies the pressurized ink to the valve mechanism 40. Each of the pumps 14 is controlled by a pressure control section (not illustrated). The pressure control sections adjust the pressure of the liquid supplied to the valve mechanisms 40 by controlling the output of each of the pumps 14. In the present embodiment, each of the pumps 14 is configured by a diaphragm pump. A mechanism that pressurizes the liquid and supplies it to other members as the pump 14 does may be referred to as a “pressurizing mechanism”. A configuration may be adopted in which the liquid ejecting apparatus 1 is not provided with a pressurizing mechanism such as the pump 14, and, for example, may adjust the relative positions of the recording heads 10 and the cartridges 11 in a gravity direction and use the hydraulic head pressure difference generated to supply the ink inside the cartridges 11 to the recording heads 10.

The valve mechanisms 40 are provided between the pumps 14 and the recording heads 10 in the liquid flow paths 30 and are arranged side by side in the X direction. In the present embodiment, four of the valve mechanisms 40 are provided, one for each of the cartridges 11. The valve mechanism 40 is provided with a valve body that operates according to the pressure on the recording head 10 side, and restricts and allows the flow of the liquid flowing inside the liquid flow path 30 using the valve body. Details of the valve mechanism 40 will be described later.

The plurality of recording heads 10 is disposed side by side in the X direction. Each of the recording heads 10 discharges any of the four color inks supplied from each of the cartridges 11 via the liquid flow path 30. A plurality of nozzles 16 for discharging the ink is provided on the surface of the recording head 10 facing the recording medium. In the present embodiment, the recording head 10 is a piezo type head and a piezo actuator for discharging ink from the nozzle 16 is provided for each of the nozzles 16. The recording head 10 is not limited to the piezo type and may be, for example, a thermal type. The four valve mechanisms 40 and the recording head 10 may be collectively referred to as a head unit 60. In another embodiment, a configuration may be adopted in which the liquid flow path 30 is branched to provide a plurality of the recording heads 10 capable of discharging two or more types of ink, or a configuration may be adopted in which only a single recording head 10 capable of discharging two or more types of ink is provided.

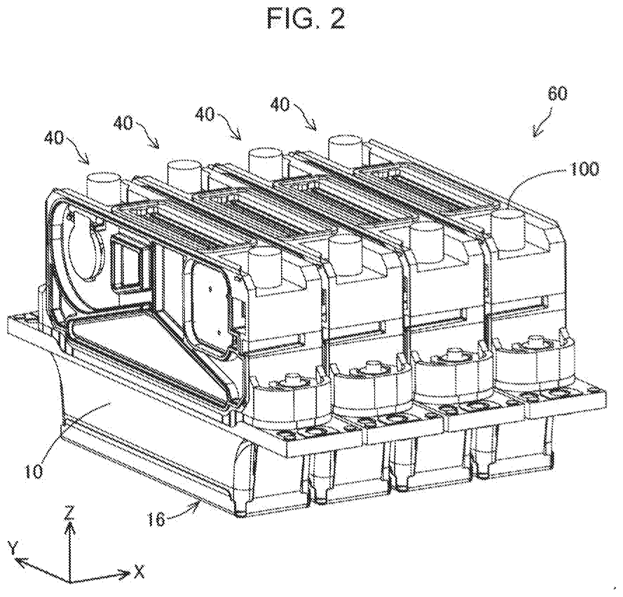

FIG. 2 is an external perspective view of the head unit 60. An arrow along the Z direction is illustrated in FIG. 2, and the Z direction is a direction along a vertical direction.

FIG. 2 illustrates the head unit 60 in which the recording head 10 and the valve mechanism 40 are integrally molded. The plurality of head units 60 is arranged side by side in the X direction. Each of the valve mechanisms 40 configuring each of the head units 60 is provided with a flow path member 100 to which the liquid is supplied from the liquid flow path 30. The nozzles 16 are provided in the surfaces of the recording heads 10 in the −Z direction, and the valve mechanisms 40 are arranged along the X direction and are mounted on to mounting portion (not illustrated) on the upper side of the recording head 10. The details of the flow path member 100 will be described later.

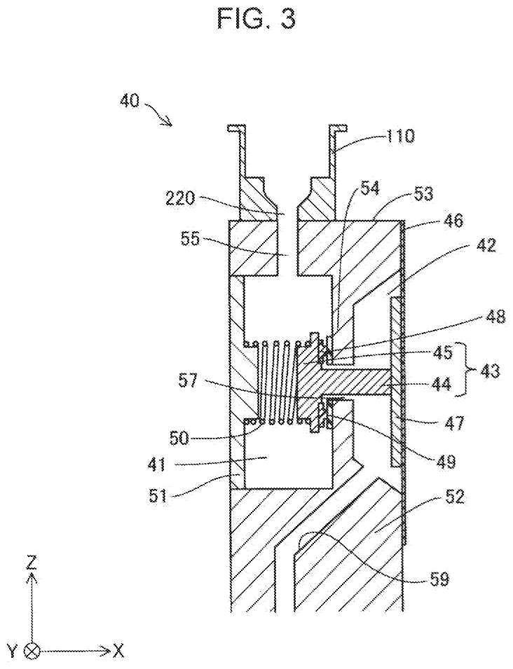

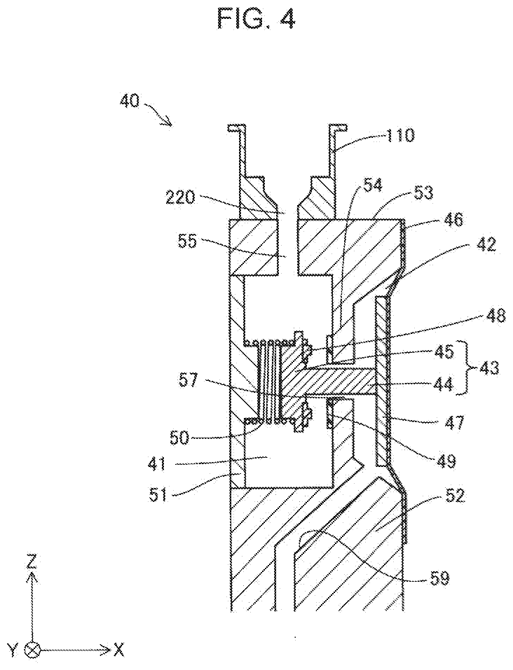

FIGS. 3 and 4 are sectional diagrams illustrating the schematic configurations of the valve mechanism 40 and the flow path member 100. FIGS. 3 and 4 illustrate cross-sections of one of the valve mechanisms 40 illustrated in FIG. 2 taken along an X-Z plane passing through the valve body. In FIGS. 3 and 4, some of the lines are omitted in order to facilitate understanding of the configuration. Furthermore, in the flow path member 100, a fixing member 130 and an elastic member 120, which will be described later, are not illustrated.

The ink supplied from the liquid flow path 30 is introduced into the valve mechanism 40 via a second flow path 220 of the flow path member 100. The valve mechanism 40 is provided with a housing 52. The housing 52 is provided with a liquid storage chamber 41 and a pressure chamber 42. The liquid storage chamber 41 is coupled to the cartridge 11 via a supply flow path 55 communicating with the second flow path 220 of the flow path member 100, and the pressure chamber 42 is coupled to the recording head 10 via a discharge flow path 59. In the present embodiment, the housing 52 of the valve mechanism 40 is formed integrally with a coupling member 110 of the flow path member 100 described later. The liquid storage chamber 41 and the pressure chamber 42 are divided by a partition wall 54. A communicating hole 57 is formed in the partition wall 54. The internal space of the liquid storage chamber 41 and the internal space of the pressure chamber 42 communicate with each other through the communicating hole 57.

A valve body 43 and a spring member 50 are provided in the liquid storage chamber 41. The valve mechanism 40 is also provided with a support member 51 that blocks a space in the housing 52 in which the liquid storage chamber 41 is formed, in other words, a recessed portion provided on the −X direction side of the housing 52. The support member 51 is provided on the outermost periphery of the valve mechanism 40 in the −X direction.

The valve body 43 is an open/close valve that switches between a state in which ink is communicated between the liquid storage chamber 41 and the pressure chamber 42 and a state in which ink is not communicated. FIG. 3 illustrates a state in which the ink is not communicated between the liquid storage chamber 41 and the pressure chamber 42. FIG. 4 illustrates a state in which the ink is communicated between the liquid storage chamber 41 and the pressure chamber 42. As illustrated in FIGS. 3 and 4, when the valve body 43 moves in the −X direction, which is the valve opening direction, the valve body 43 opens and ink is communicated between the liquid storage chamber 41 and the pressure chamber 42. When the valve body 43 moves in the +X direction, which is the valve closing direction, the valve body 43 closes and the ink is not communicated between the liquid storage chamber 41 and the pressure chamber 42. Details of the opening and closing of the valve body 43 and the flow of ink in the valve mechanism 40 will be described later.

As illustrated in FIG. 3, the valve body 43 is inserted into the communicating hole 57 formed in the partition wall 54. More specifically, the valve body 43 includes a shaft 44 protruding from the partition wall 54 in the +X direction and a flange portion 45 provided in the liquid storage chamber 41. An end portion of the shaft 44 in the +X direction is in contact with a pressure receiving plate 47 described later. The flange portion 45 is provided at the end portion of the shaft 44 in the −X direction.

As illustrated in FIGS. 3 and 4, the valve body 43 includes a seal member 48 in an annular shape. The seal member 48 is provided on the +X direction side of the flange portion 45 and is disposed to be capable of being in contact with a valve seat 49. The valve seat 49 is formed of SUS or the like having a cylindrical shape. When the valve body 43 is in a closed state, the seal member 48 is pressed against and is in contact with the valve seat 49 provided on the −X direction surface of the partition wall 54. Therefore, the flow of ink from the liquid storage chamber 41 to the pressure chamber 42 is blocked. On the other hand, as illustrated in FIG. 4, when the valve body 43 is in an open state, the seal member 48 is not in contact with the valve seat 49 and the ink flows from the liquid storage chamber 41 into the pressure chamber 42.

As illustrated in FIG. 3, the spring member 50 is provided on the +X direction side of the support member 51. The spring member 50 biases the valve body 43 in the +X direction toward the partition wall 54 when viewed from the spring member 50. When the valve body 43 is in a closed state, the spring member 50 presses the flange portion 45 of the valve body 43 toward the valve seat 49 provided on the partition wall 54. On the other hand, as illustrated in FIG. 4, when the valve body 43 is in an open state, the spring member 50 is pressed against the support member 51 by the valve body 43. The support member 51 supports the spring member 50.

Next, the configuration of the pressure chamber 42 will be described. The pressure chamber 42 is provided with a flexible film 46 and the pressure receiving plate 47. The flexible film 46 is disposed to the +X direction in the pressure chamber 42. The flexible film 46 partitions the pressure chamber 42 and the outside of the valve mechanism 40 in the +X direction. The flexible film 46 is formed of a flexible elastic thin film and is deformed according to the pressure inside the pressure chamber 42. Specifically, when the pressure inside the pressure chamber 42 increases, the flexible film 46 deforms to the +X direction side toward the outside of the pressure chamber 42, and when the pressure inside the pressure chamber 42 decreases, the flexible film 46 deforms to the −X direction side toward the inside of the pressure chamber 42. A snap-action mechanism that deforms greatly at a greater than or equal to a fixed pressure may be adopted as the flexible film 46.

The pressure receiving plate 47 is disposed on the pressure chamber 42 side of the flexible film 46. The pressure receiving plate 47 receives pressure on the pressure chamber 42 side of the flexible film 46. In other words, the pressure receiving plate 47 is pressed toward the partition wall 54 by the deformation of the flexible film 46 toward the pressure chamber 42 side. At this time, the shaft 44 and the valve body 43 move in a direction that distances the shaft 44 and the valve body 43 away from the valve seat 49.

Next, the operation of the valve mechanism 40 will be described. As illustrated in FIG. 3, the ink is pressurized and supplied to the liquid storage chamber 41 via the liquid flow path 30, the second flow path 220, and the supply flow path 55. When ink is discharged from the nozzles 16 of the recording head 10, the flow paths inside the recording head 10 assume a negative pressure and the pressure is transmitted to the pressure chamber 42 of the valve mechanism 40 on upstream of the recording head 10. When the pressure inside the pressure chamber 42 becomes negative, as illustrated in FIG. 4, the flexible film 46 flexibly deforms in the −X direction, which is a direction toward the inside of the pressure chamber 42. Furthermore, when the pressure inside the pressure chamber 42 becomes less than or equal to a predetermined negative pressure, the pressure receiving plate 47 is pressed and moves to the partition wall 54 side as the flexible film 46 is deformed. At this time, the pressure receiving plate 47 pushes the end portion of the shaft 44 to move the valve body 43 in the −X direction, which is the valve opening direction. Then, the valve body 43 opens and the liquid storage chamber 41 and the pressure chamber 42 communicate with each other. The magnitude of the predetermined negative pressure inside the pressure chamber 42 when the valve body 43 opens and the liquid storage chamber 41 and the pressure chamber 42 communicate with each other is, for example, is set according to the meniscus shape of the desired nozzle 16 during the discharging. The negative pressure means a pressure lower than the atmospheric pressure.

Since the ink supplied into the liquid storage chamber 41 is pressurized by the pump 14, when the ink is supplied into the liquid storage chamber 41, the pressure inside the liquid storage chamber 41 rises. The ink supplied under pressure flows from the liquid storage chamber 41 into the pressure chamber 42, so that the pressure inside the pressure chamber 42 also rises. At this time, the flexible film 46 is deformed in the +X direction toward the outside of the pressure chamber 42. With the deformation of the flexible film 46, the pressure receiving plate 47 and the valve body move in the +X direction, which is the valve closing direction, and the valve body 43 closes as illustrated in FIG. 3. At this time, the seal member 48 comes into contact with the valve seat 49, whereby the flow of ink from the liquid storage chamber 41 to the pressure chamber 42 is blocked. In other words, the valve body 43 provided in the valve mechanism 40 is capable of blocking the communicating hole 57, and opens the communicating hole 57 when the pressure inside the pressure chamber 42 becomes less than or equal to a predetermined negative pressure.

As described above, the valve mechanism 40 controls the flow of the ink from the cartridge 11 to the recording head 10 by moving the valve body 43 in the valve opening direction or the valve closing direction according to the pressure inside the pressure chamber 42. The valve mechanism 40 may also be referred to as a “self-sealing valve” or a “differential pressure valve”. The valve mechanism 40 also serves to prevent the pressure applied from the pump 14 from directly acting on the recording head 10 in the negative pressure state.

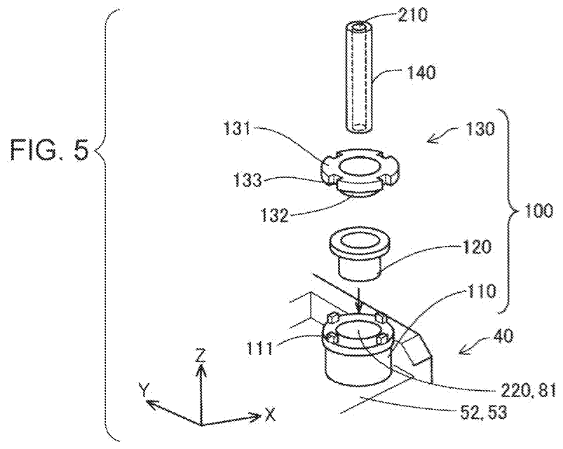

FIG. 5 is an exploded perspective view illustrating the configuration of the flow path member 100 provided in the valve mechanism 40. FIG. 5 illustrates the flow path member 100 and a pipe 140 inserted into the flow path member 100. The flow path member 100 is configured of the coupling member 110 having a recessed portion 81 (described later), the elastic member 120, and the fixing member 130. The pipe 140 is a member including a first flow path 210 which is a liquid flow path inside the pipe 140. In the present embodiment, the pipe 140 is a substantially cylindrical member and the first flow path 210 configures a portion of the liquid flow path 30. One end of a flexible tube configuring the liquid flow path 30 is coupled to the pipe 140. A configuration may be adopted in which the cartridge 11 is provided with the pipe 140, and the cartridge 11 and the valve mechanism 40 are coupled to each other without interposing a tube therebetween. For example, one end of the pipe 140 may be tapered. In other words, the pipe 140 may be a needle-shaped member including the first flow path 210 inside the pipe 140.

The flow path member 100 is configured by sequentially inserting the elastic member 120 and the fixing member 130 into the recessed portion 81 provided in the coupling member 110. In the present embodiment, the coupling member 110 protrudes in the +Z direction from a top surface 53 of the housing 52 on the +Z direction side and the coupling member 110 is formed integrally with the housing 52.

By inserting the pipe 140 into the flow path member 100, the first flow path 210 inside the pipe 140 and the second flow path 220 of the flow path member 100 communicate with each other. In the present embodiment, the liquid introduced from the first flow path 210 to the second flow path 220 flows to the recording head 10 positioned downstream of the discharge flow path 59.

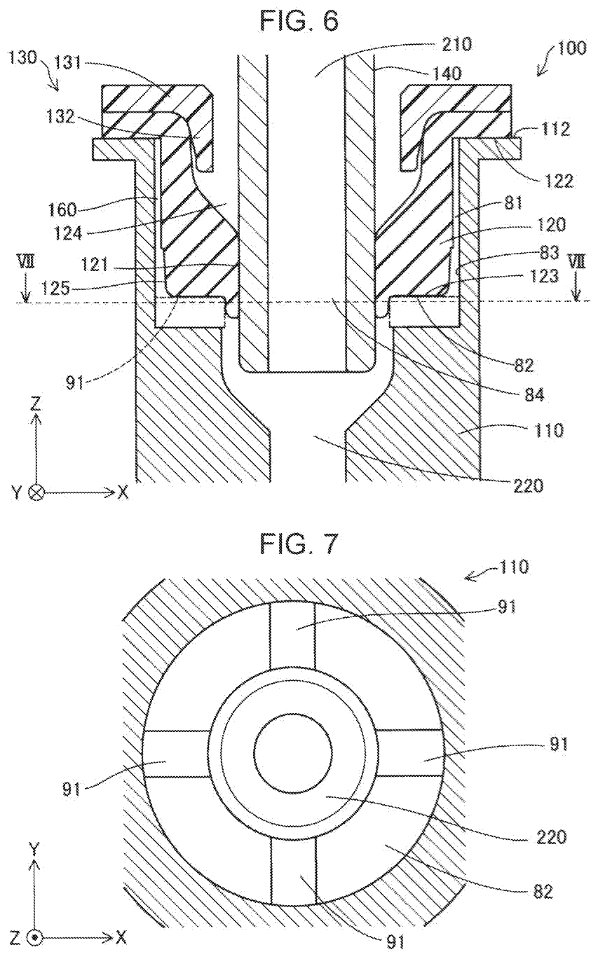

FIG. 6 is a sectional diagram illustrating the configuration of the flow path member 100 in the present embodiment. FIG. 6 illustrates a cross-section of the flow path member 100 taken along a plane passing through the flow path member 100 along the XY direction. FIG. 6 illustrates the coupling member 110 configuring the flow path member 100, the elastic member 120, the fixing member 130, and the pipe 140 that is inserted into the flow path member 100. As illustrated in FIG. 6, the configuration including the flow path member 100 and the pipe 140 may be referred to as a flow path unit.

The coupling member 110 includes the second flow path 220 that communicates with the first flow path 210 inside the pipe 140. As illustrated in FIG. 3, in the present embodiment, the second flow path 220 is also in communication with the supply flow path 55 of the valve mechanism 40. The extending direction of the first flow path 210 may be referred to as an extending direction. In the present embodiment, the extending direction is along the Z direction.

The coupling member 110 has a substantially cylindrical shape. A coupling surface 112 of the coupling member 110 is provided with a recessed portion 81 in a substantially cylindrical shape. An opening 84 is provided on a bottom surface 82 of the recessed portion 81. The second flow path 220 is provided to communicate with the opening 84 of the bottom surface 82. The coupling surface 112 is a surface that intersects the extending direction, and is a surface of the coupling member 110 on the side to which the pipe 140 is coupled. In the present embodiment, one end of the coupling member 110, which is formed in a brim shape configures the coupling surface 112. The recessed portion 81 is a portion in which the coupling surface 112 is depressed toward the −Z direction which is the insertion direction of the pipe 140. The elastic member 120 and the pipe 140 are inserted into the recessed portion 81. In the present embodiment, a contact surface 123 of the elastic member 120 inserted into the recessed portion 81 is in contact with the bottom surface 82 of the recessed portion 81. The coupling member 110 may not necessarily have a substantially cylindrical shape. For example, the top surface 53 of the valve mechanism 40 on the +Z direction side of the housing 52 may function as the coupling surface 112, and the housing 52 may configure the coupling member 110. At this time, the supply flow path 55 provided in the valve mechanism 40 corresponds to the second flow path 220 provided in the coupling member 110. Further, the coupling member 110 and the housing of the valve mechanism 40 may not necessarily be integrally formed.

The elastic member 120 is a substantially cylindrical member provided with a through hole 124 for inserting the pipe 140. The elastic member 120 is a member that holds the pipe 140 inserted into the through hole 124 by the inner circumferential surface of the through hole 124, and is formed of an elastic rubber in the present embodiment.

One end of the elastic member 120 of the present embodiment into which the pipe 140 is inserted is formed in a brim shape. The elastic member 120 includes a first seal portion 121 and a second seal portion 122. The first seal portion 121 is a portion of the inner circumferential surface of the through hole 124 being in contact with the pipe 140 inserted into the elastic member 120. The second seal portion 122 is a portion of the elastic member 120 being in contact with the coupling member 110. The second seal portion 122 is provided apart from the bottom surface 82 in the extending direction. In the present embodiment, the second seal portion 122 is in contact with the coupling surface 112 of the coupling member 110 and is a portion of the lower surface of the brim-shaped portion of the elastic member 120. The first seal portion 121 and the second seal portion 122 liquid-tightly seal the portions provided with the respective seal portions such that liquid does not leak.

A gap 160 is provided between an outer circumferential surface 125 of the elastic member 120 and the inner circumferential surface of the recessed portion 81. Specifically, in the space between the second seal portion 122 and the bottom surface 82, the gap 160 is provided between the outer circumferential surface 125 of the portion of the elastic member 120 inserted into the recessed portion 81 and an inner circumferential surface 83 of the recessed portion 81. In the present embodiment, the gap 160 and the second flow path 220 communicate with each other via a first groove 91 provided on the bottom surface 82 of the recessed portion 81. In FIG. 6, the portion where the first groove 91 is provided is illustrated as a portion surrounded by a broken line.

The fixing member 130 is a member that fixes the elastic member 120 to the coupling member 110. The fixing member 130 of the present embodiment is a substantially cylindrical member provided with a through hole for inserting the pipe 140 and is formed of resin. The fixing member 130 includes a first fixing portion 131 that is one end on the side where the pipe 140 is inserted and is formed in a brim shape, and a second fixing portion 132 that is inserted into the through hole 124 of the elastic member 120. The first fixing portion 131 restricts the movement of the elastic member 120 by pressing the brim-shaped portion of the elastic member 120 from the +Z direction toward the coupling surface 112 in a state in which the second fixing portion 132 is inserted into the through hole 124. As illustrated in FIG. 5, the first fixing portion 131 is fixed to the coupling member 110 by melting a portion of a protruding portion 111 by heat staking. The second fixing portion 132 restricts the movement of the elastic member 120 by bringing the outer circumferential surface of the second fixing portion 132 into contact with the inner circumferential surface of the through hole 124.

FIG. 7 is a sectional diagram taken along line VII-VII illustrating the bottom surface 82 of the recessed portion 81 of the coupling member 110. FIG. 7 illustrates a sectional diagram of the coupling member 110 in a state in which the elastic member 120, the fixing member 130, and the pipe 140 are not inserted. As illustrated in FIG. 7, the bottom surface is provided with four rectangular grooves that are depressed in the −Z direction as the first grooves 91. Since the first grooves 91 are not blocked by the contact surface 123 of the elastic member 120 being in contact with the bottom surface 82, the gap 160 and the second flow path 220 communicate with each other via the first grooves 91. Therefore, the liquid inside the second flow path 220 may flow into the gap 160 through the first groove 91.

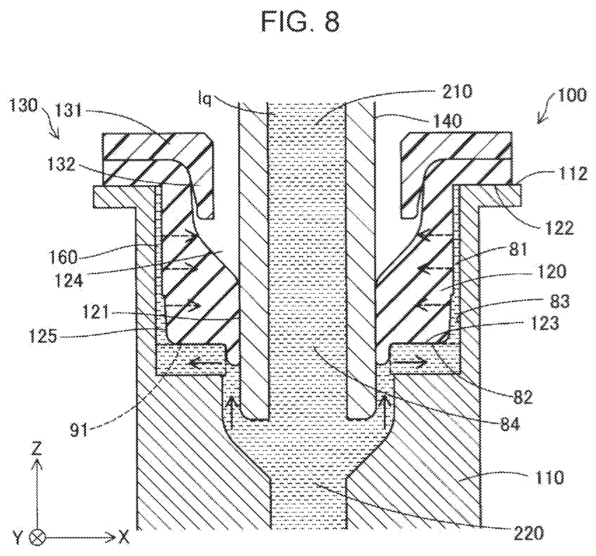

FIG. 8 is an explanatory diagram illustrating a state in which an ink 1q inside the flow path member 100 flows into the gap 160. FIG. 8 illustrates the flow of the ink 1q using arrows. A state in which the elastic member 120 is pushed inward by the ink 1q flowing into the gap 160 is illustrated using broken lines and the arrows. The elastic member 120 is pushed inward by the ink 1q flowing into the gap 160, so that the sealing performance of the first seal portion 121 is improved. In particular, in the present embodiment, the valve mechanism 40 is provided downstream of the flow path member 100, and as described above, when the valve mechanism 40 blocks the supply of ink to the recording head 10, the pressure inside the liquid storage chamber 41 of the valve mechanism 40 is increased. At this time, the pressure inside the second flow path 220 is also increased, and the pressurized ink flows into the gap 160, so that the sealing performance of the first seal portion 121 is more effectively improved.

According to the flow path member 100 of the present embodiment described above, in the space between the second seal portion 122 and the bottom surface 82, the gap 160 is provided between the outer circumferential surface 125 of the portion of the elastic member 120 inserted into the recessed portion 81 and the inner circumferential surface 83 of the recessed portion 81. Accordingly, the liquid inside the second flow path 220 flows into the gap 160 and pushes the elastic member 120 inward, so that the sealing performance of the first seal portion 121 is improved. Therefore, it is possible to suppress leakage of the liquid from the flow path member 100.

In the present embodiment, the elastic member 120 includes the contact surface 123 being in contact with the bottom surface 82 of the recessed portion 81. Therefore, the elastic member 120 is supported by the bottom surface 82 of the recessed portion 81 and the inclination of the elastic member 120 with respect to the extending direction is suppressed.

In the present embodiment, the bottom surface 82 of the recessed portion 81 is provided with the first grooves 91 that cause the second flow path 220 and the gap 160 to communicate with each other. Therefore, even when the contact surface 123 of the elastic member 120 is in contact with the bottom surface 82 of the recessed portion 81, it is possible to cause the liquid inside the second flow path 220 to flow into the gap 160 via the first grooves 91.

In the present embodiment, the second seal portion 122 of the elastic member 120 is in contact with the coupling surface 112 of the coupling member 110. As a result, the distance between the first seal portion 121 and the second seal portion 122 becomes long as compared to when the second seal portion 122 is in contact with the inner circumferential surface 83 of the recessed portion 81. Therefore, it is possible to improve the following performance of the elastic member 120 with respect to the pipe 140 while maintaining the sealing performance of the first seal portion 121 and the second seal portion 122.

### B. Second Embodiment

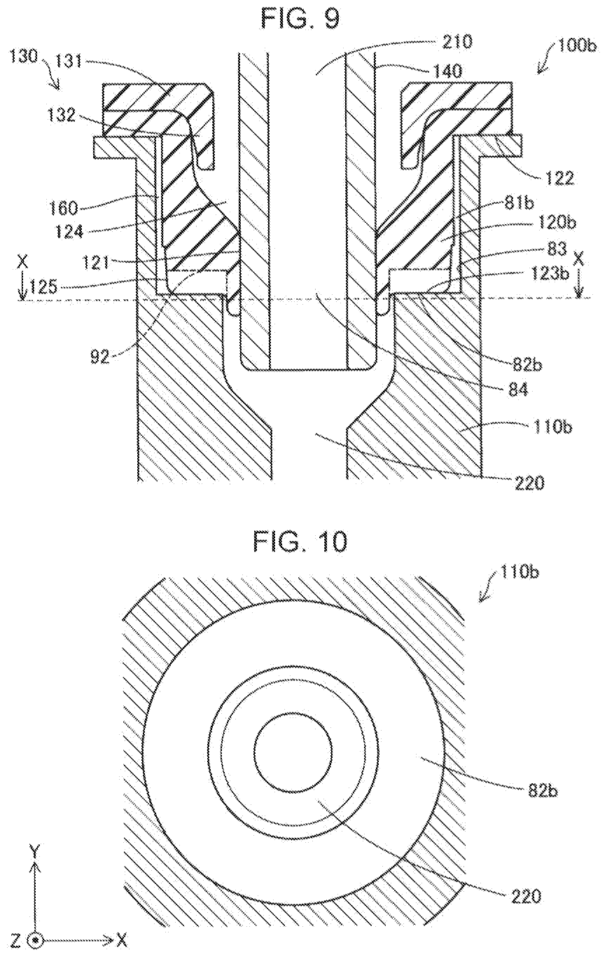

FIG. 9 is a sectional diagram illustrating the configuration of a flow path member 100b in the second embodiment. In the present embodiment, the configurations of a coupling member 110b and an elastic member 120b are different from those in the first embodiment. Of the flow path member 100b, portions that are not particularly described have the same configuration as those of the flow path member 100 of the first embodiment.

FIG. 10 is a sectional diagram taken along line X-X illustrating a bottom surface 82b of the recessed portion 81b of the coupling member 110b. As illustrated in FIGS. 9 and 10, in the present embodiment, the first grooves 91 are not provided in the bottom surface 82b.

In the present embodiment, a contact surface 123b of the elastic member 120b is provided with four rectangular grooves that are depressed in the +Z direction as second grooves 92. The four second grooves 92 are disposed at equal intervals to surround the through holes 124 provided in the elastic member 120b. FIG. 9 illustrates the positions of two of the second grooves 92 among the four second grooves 92 using broken lines. Since the second grooves 92 are not blocked by the bottom surface 82b being in contact with the contact surface 123b of the elastic member 120b, the gap 160 and the second flow path 220 communicate with each other via the second grooves 92. Therefore, the liquid inside the second flow path 220 may flow into the gap 160 through the second groove 92.

The flow path member 100b of the second embodiment described above is also capable of suppressing the leakage of the liquid from the flow path member 100b. In particular, in the present embodiment, the contact surface 123b of the elastic member 120b is provided with the second grooves 92 that cause the second flow path 220 and the gap 160 to communicate with each other. Therefore, even when the contact surface 123b is in contact with the bottom surface 82b of the recessed portion 81b, it is possible to cause the liquid inside the second flow path 220 to flow into the gap 160 via the second grooves 92.

### C. Third Embodiment

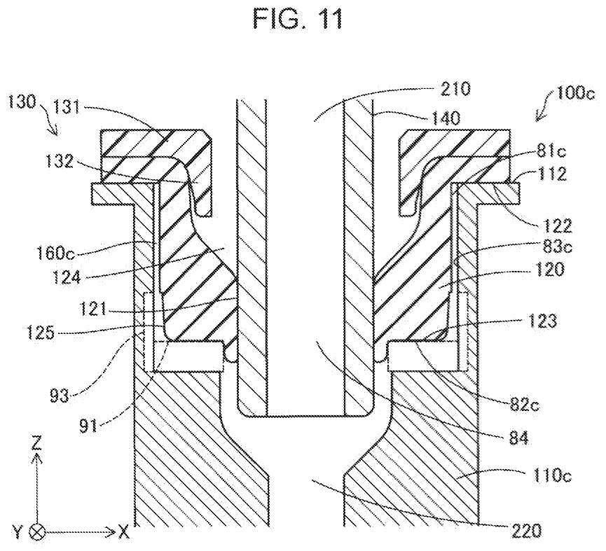

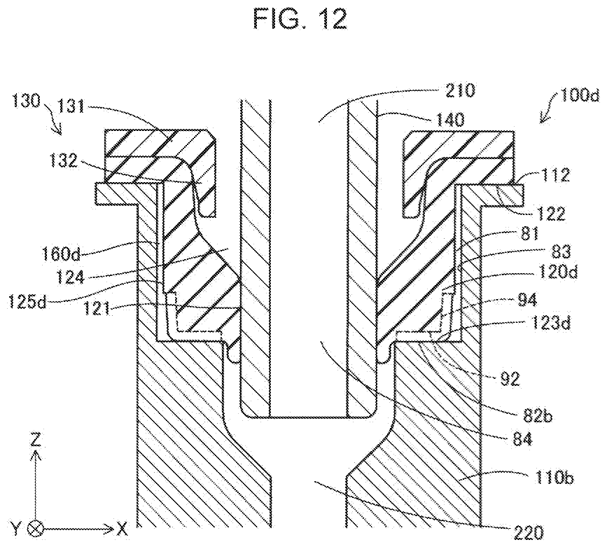

FIG. 11 is a sectional diagram illustrating the configuration of a flow path member 100c according to the third embodiment. In the present embodiment, the configuration of a coupling member 110c is different from that of the first embodiment. Of the flow path member 100c, portions that are not particularly described have the same configuration as those of the flow path member 100 of the first embodiment.

The coupling member 110c includes third grooves 93 provided in an inner circumferential surface 83c of the recessed portion 81c in addition to the first grooves 91 provided in a bottom surface 82c of the recessed portion 81c. The third grooves 93 define a portion of a gap 160c. In the present embodiment, the third grooves 93 are continuous with the first grooves 91.

The flow path member 100c of the third embodiment described above is also capable of suppressing the leakage of the liquid from the flow path member 100c. Particularly, in the present embodiment, the third grooves 93 that define a portion of the gap 160c are provided in the inner circumferential surface 83c of the recessed portion 81c provided in the coupling member 110c. Therefore, even when the position of the elastic member 120 changes due to pressure fluctuations inside the flow path of the flow path member 100c, movement of the pipe 140, or the like, it is possible to cause the liquid to effectively flow into the gap 160c.

In the present embodiment, the third grooves 93 are continuous with the first grooves 91. Therefore, the liquid inside the second flow path 220 is capable of flowing into the gap 160c by flowing toward the first grooves 91 via the third grooves 93.

### D. Fourth Embodiment

FIG. 12 is a sectional diagram illustrating the configuration of a flow path member 100d in the fourth embodiment. In the present embodiment, the configuration of an elastic member 120d is different from that of the second embodiment. Of the flow path member 100d, portions that are not particularly described have the same configuration as those of the flow path member 100b of the second embodiment.

The elastic member 120d includes fourth grooves 94 provided in an outer circumferential surface 125d in addition to the second grooves 92 provided in a contact surface 123d. The fourth grooves 94 define a portion of a gap 160d. In the present embodiment, the fourth grooves 94 are continuous with the second grooves 92.

The flow path member 100d of the fourth embodiment described above is also capable of suppressing the leakage of the liquid from the flow path member 100d. Particularly, in the present embodiment, the outer circumferential surface 125d of the elastic member 120d is provided with the fourth grooves 94 that define a portion of the gap 160d. Therefore, even when the position of the elastic member 120d changes due to pressure fluctuations inside the flow path of the flow path member 100d, movement of the pipe 140, or the like, it is possible to cause the liquid to effectively flow into the gap 160d.

Further, in the present embodiment, the fourth grooves 94 are continuous with the second grooves 92. Therefore, the liquid inside the second flow path 220 is capable of flowing into the gap 160d by flowing toward the fourth grooves 94 via the second grooves 92.

### E. Other Embodiments

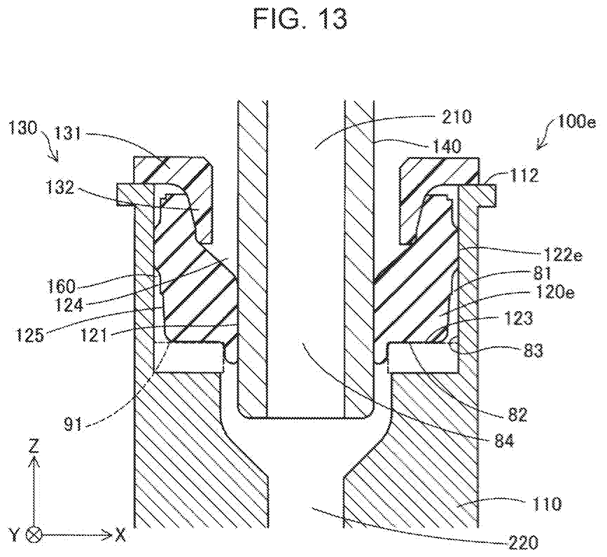

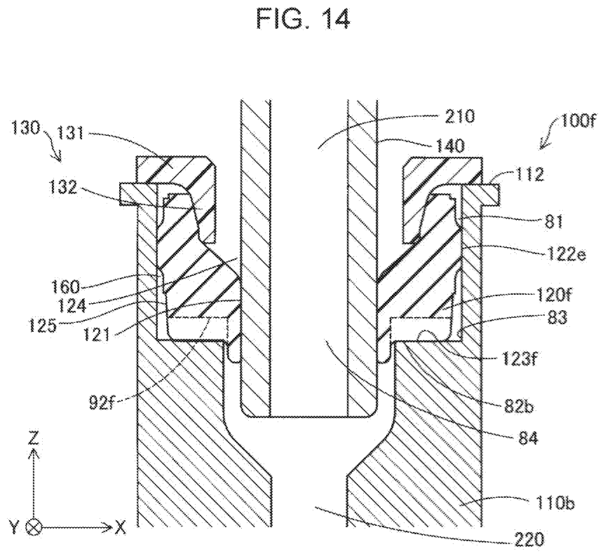

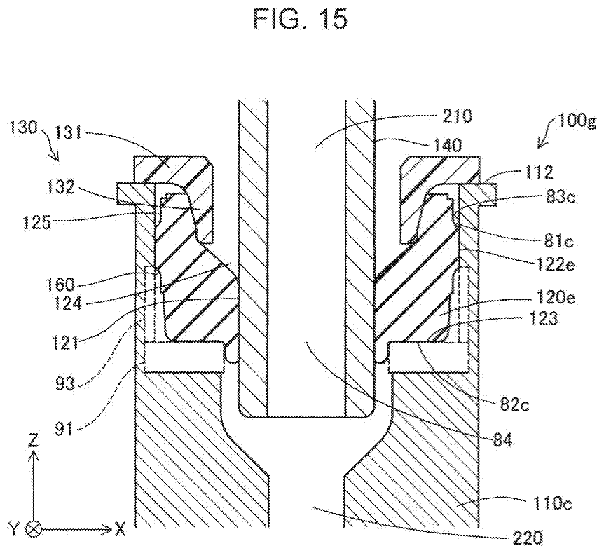

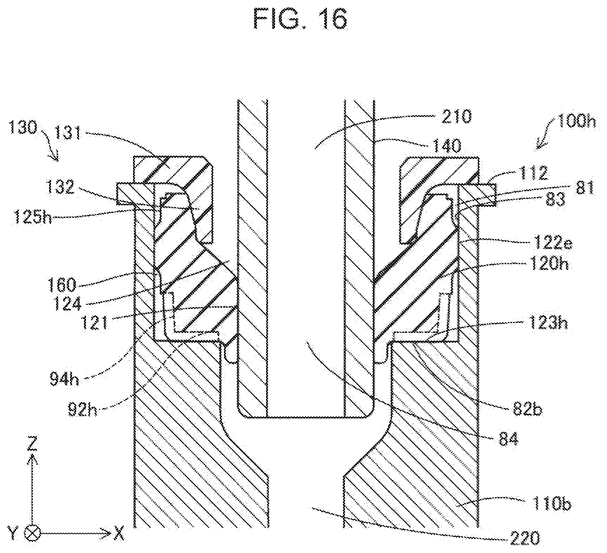

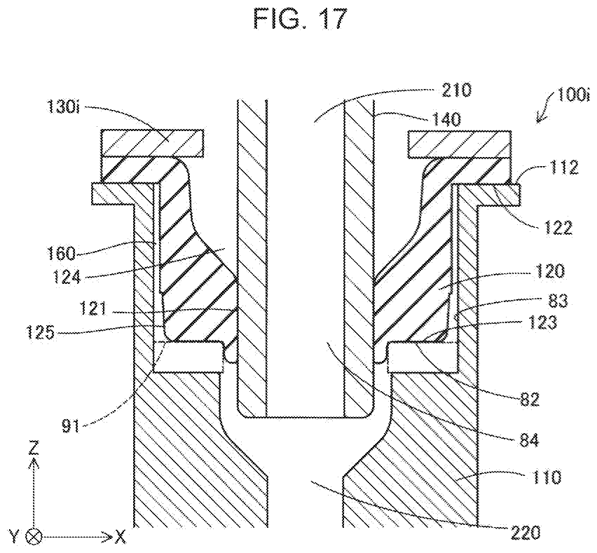

(E-1) FIG. 13 is a sectional diagram illustrating the configuration of a flow path member 100e as another embodiment including the first grooves 91. In the above embodiment, a second seal portion 122e of an elastic member 120e is in contact with the coupling surface 112 of the coupling member 110. On the other hand, as illustrated in FIG. 13, a configuration may be adopted in which the second seal portion 122e is in contact with the inner circumferential surface 83 of the recessed portion 81 without being in contact with the coupling surface 112. FIG. 14 is a sectional diagram illustrating the configuration of a flow path member 100f as another embodiment including second grooves 92f. The flow path member 100f is provided with the second grooves 92f in a contact surface 123f of an elastic member 120f, similarly to the flow path member 100b of the second embodiment. FIG. 15 is a sectional diagram illustrating a configuration of a flow path member 100g as another embodiment including the first grooves 91 and the third grooves 93. FIG. 16 is a sectional diagram illustrating a configuration of a flow path member 100h as another embodiment including second grooves 92f and fourth grooves 94h. The flow path member 100h includes second grooves 92h provided in a contact surface 123h of an elastic member 120h and fourth grooves 94h provided in an outer circumferential surface 125h, similarly to the flow path member 100d of the fourth embodiment. Even in the embodiments illustrated in FIGS. 13 to 16, it is possible to suppress liquid leakage in the same manner as in the first to fourth embodiments.

(E-2) In the above embodiment, the fixing member 130 is a substantially cylindrical member including the first fixing portion 131 and the second fixing portion 132. On the other hand, the fixing member 130 may have another shape. For example, FIG. 17 illustrates a flow path member 100i including a fixing member 130i in an annular shape. Similarly to the first fixing portion 131 of the fixing member 130, the fixing member 130i restricts the movement of the elastic member 120 in the Z direction by pressing the brim-shaped portion of the elastic member 120 from the +Z direction toward the coupling surface 112. At this time, it is more preferable that the fixing member 130i be configured of resin or metal having high rigidity, and it is possible to improve the sealing performance of the second seal portion 122 over a wide range. In this manner, as long as a configuration is adopted in which the second seal portion 122 is in contact with the coupling surface 112 of the coupling member 110, it is possible to fix the elastic member 120 using the fixing member 130i even if the fixing member 130i has an annular shape. In this case, the flow path member 100 may not necessarily include the fixing member 130. For example, the elastic member 120 may be directly caulked and fixed to the coupling member 110.

(E-3) In the above embodiment, the first flow path 210 is upstream and the second flow path 220 is downstream with respect to the liquid. On the other hand, the first flow path 210 may be downstream and the second flow path 220 may be upstream. Even in this case, by pressurizing the second flow path 220, leakage of the liquid is similarly suppressed.

(E-4) In the above embodiment, the liquid inside the second flow path 220 flows into the gap 160 via the first grooves 91 provided in the bottom surface 82 and the second grooves 92 provided in the contact surface 123b. On the other hand, the first groove 91 and the second groove 92 may not necessarily be provided. For example, the bottom surface 82 and the contact surface 123 may be provided with protrusions instead of grooves. In this case, the liquid inside the second flow path 220 is capable of flowing into the gap 160 via portions of the bottom surface 82 and the contact surface 123 where no protrusions are provided.

(E-5) In the above embodiment, the elastic member 120 includes the contact surface 123 being in contact with the bottom surface 82 of the recessed portion 81. On the other hand, the elastic member 120 may not necessarily include the contact surface 123. In this case, for example, the second flow path 220 and the gap 160 may be caused to communicate with each other by the space provided between the lower surface and the bottom surface 82 of the elastic member 120 without providing grooves or protrusions on the lower surface of the elastic member 120 or the bottom surface 82 of the recessed portion 81.

(E-6) In the above embodiment, the first grooves 91 and the third grooves 93 communicate with each other, and the second grooves 92 and the fourth grooves 94 communicate with each other. On the other hand, the first grooves 91 and the third grooves 93 may not necessarily communicate with each other. Similarly, the second groove 92 and the fourth groove 94 may not necessarily communicate with each other. Each of the grooves may be provided in a combination other than those described in the above embodiments. For example, the first grooves 91 and the fourth grooves 94 may be provided, or all the grooves may be provided. The number of each of the grooves may be less than or equal to three, or may be greater than or equal to five, instead of four. In this case, it is preferable that each groove be provided such that the elastic member 120 is uniformly pressed by the liquid that flows into the gap 160.

(E-7) In the above embodiment, the valve mechanism 40 serving as a self-sealing valve is disposed downstream of the flow path member 100. On the other hand, the valve mechanism 40 may not necessarily be provided downstream of the flow path member 100.

(E-8) In the above embodiment, although the coupling member 110 of the flow path member 100 is formed integrally with the housing of the valve mechanism 40, the coupling member 110 may be provided on another member or the like configuring the liquid flow path 30. For example, the flow path member 100 may be provided in the recording head 10. In this case, in the recording head 10, the flow path member 100 may be provided in the coupling portion with the liquid flow path 30, the coupling portion with the cartridge 11, the coupling portion with the valve mechanism 40, or the like.

(E-9) In the above embodiment, the flow path member 100 is provided as a member that introduces the ink from the liquid flow path 30 upstream. On the other hand, for example, the flow path member 100 may be provided as a member that discharges the liquid from an optional element forming the liquid flow path 30. For example, a configuration may be adopted in which the ink flowing through the discharge flow path 59 is discharged from the flow path member 100 toward the nozzle 16 by disposing the flow path member 100 downstream of the valve mechanism 40.

### F. Other Forms

The present disclosure is not limited to the above embodiments, and may be implemented in various forms in a range not departing from the spirit of the present disclosure. For example, the present disclosure may be implemented as the following forms. The technical features in each of the above embodiments corresponding to the technical features in each of the forms described below may be replaced or combined, as appropriate, in order to solve part or all of the problems of the present disclosure, or part or all of the effects of the present disclosure. As long as the technical features are not described as essential in this specification, it is possible to delete the technical features as appropriate.

(1) According to a first aspect of the present disclosure, a flow path member is provided. The flow path member coupled to a pipe including a first flow path inside the pipe includes a coupling member including a coupling surface that is a surface intersecting an extending direction in which the first flow path extends and that is provided with a recessed portion into which the pipe is inserted and a second flow path that communicates with the first flow path and communicates with an opening provided in a bottom surface of the recessed portion, and an elastic member that is inserted into the recessed portion of the coupling member and is provided with a through hole into which the pipe is inserted, in which the elastic member includes a first seal portion being in contact with an outer circumferential surface of the pipe on an inner circumferential surface of the through hole and a second seal portion being provided apart from the bottom surface in the extending direction and being in contact with the coupling member, between the second seal portion and the bottom surface, a gap is provided between an outer circumferential surface of a portion of the elastic member inserted into the recessed portion and an inner circumferential surface of the recessed portion, and the gap communicates with the second flow path.

According to this configuration, the liquid inside the second flow path flows into the gap and pushes the elastic member inward, so that the sealing performance of the first seal portion is improved. Therefore, it is possible to suppress leakage of the liquid from the flow path member.

(2) In the flow path member of the above aspect, the elastic member may include a contact surface being in contact with the bottom surface of the recessed portion. According to this configuration, since the elastic member is supported by the bottom surface of the recessed portion, it is possible to suppress the inclination of the elastic member with respect to the extending direction.

(3) In the flow path member of the above aspect, the bottom surface of the recessed portion may be provided with a first groove through which the second flow path and the gap communicate. According to this configuration, even when the contact surface of the elastic member is in contact with the bottom surface of the recessed portion, it is possible to cause the liquid inside the second flow path to flow into the gap via the first groove.

(4) In the flow path member of the above aspect, the contact surface of the elastic member may be provided with a second groove through which the second flow path and the gap communicate. According to this configuration, even when the contact surface of the elastic member is in contact with the bottom surface of the recessed portion, it is possible to cause the liquid inside the second flow path to flow into the gap via the second groove.

(5) In the flow path member of the above aspect, the inner circumferential surface of the recessed portion may be provided with a third groove that defines the gap. According to this configuration, even when the position of the elastic member changes due to pressure fluctuations inside the flow path of the flow path member, movement of the pipe, or the like, it is possible to cause the liquid to effectively flow into the gap.

(6) In the flow path member of the above-described aspect, an outer circumferential surface of the elastic member may be provided with a fourth groove that defines the gap. According to this configuration, even when the position of the elastic member changes due to pressure fluctuations inside the flow path of the flow path member, movement of the pipe, or the like, it is possible to cause the liquid to effectively flow into the gap.

(7) In the flow path member of the above-described aspect, the elastic member may include a contact surface being in contact with the bottom surface of the recessed portion, the bottom surface of the recessed portion may be provided with a first groove through which the second flow path and the gap communicate, the inner circumferential surface of the recessed portion may be provided with a third groove that defines the gap, and the first groove and the third groove may be continuous. According to this configuration, the liquid inside the second flow path is capable of flowing into the gap by flowing toward the first groove via the third groove.

(8) In the flow path member of the above aspect, the elastic member may include a contact surface being in contact with the bottom surface of the recessed portion, the contact surface of the elastic member may be provided with a second groove through which the second flow path and the gap communicate, an outer circumferential surface of the elastic member may be provided with a fourth groove that defines the gap, and the second groove and the fourth groove may be continuous. According to this configuration, the liquid inside the second flow path is capable of flowing into the gap by flowing toward the fourth groove via the second groove.

(9) In the flow path member of the above aspect, the second seal portion may be in contact with the coupling surface. According to this configuration, it is possible to render the distance between the first seal portion and the second seal portion long as compared to when the second seal portion is in contact with the inner circumferential surface of the recessed portion. Therefore, it is possible to improve the following performance of the elastic member with respect to the pipe while maintaining the sealing performance of the first seal portion and the second seal portion.

The present disclosure is not limited to the flow path member described above, and may be realized in various forms. For example, the present disclosure may be realized in the form of a flow path unit, a liquid ejecting apparatus, or the like.

What is claimed is:

1. A flow path member coupled to a pipe including a first flow path inside the pipe, the flow path member comprising:
a coupling member including
a coupling surface that is a surface intersecting an extending direction in which the first flow path extends and that is provided with a recessed portion into which the pipe is inserted and
a second flow path that communicates with the first flow path and communicates with an opening provided in a bottom surface of the recessed portion; and
an elastic member that is inserted into the recessed portion of the coupling member and is provided with a through hole into which the pipe is inserted, wherein
the elastic member includes a first seal portion being in contact with an outer circumferential surface of the pipe on an inner circumferential surface of the through hole and a second seal portion being provided apart from the bottom surface in the extending direction and being in contact with the coupling member,
between the second seal portion and the bottom surface, a gap is provided between an outer circumferential surface of a portion of the elastic member inserted into the recessed portion and an inner circumferential surface of the recessed portion, and
the gap communicates with the second flow path.

2. The flow path member according to claim 1, wherein
the elastic member includes a contact surface being in contact with the bottom surface of the recessed portion.

3. The flow path member according to claim 2, wherein
the bottom surface of the recessed portion is provided with a first groove through which the second flow path and the gap communicate.

4. The flow path member according to claim 2, wherein
the contact surface of the elastic member is provided with a second groove through which the second flow path and the gap communicate.

5. The flow path member according to claim 3, wherein
the contact surface of the elastic member is provided with a second groove through which the second flow path and the gap communicate.

6. The flow path member according to claim 1, wherein
the inner circumferential surface of the recessed portion is provided with a third groove that defines the gap.

7. The flow path member according to claim 6, wherein
an outer circumferential surface of the elastic member is provided with a fourth groove that defines the gap.

8. The flow path member according to claim 6, wherein
an outer circumferential surface of the elastic member is provided with a fourth groove that defines the gap.

9. The flow path member according to claim 1, wherein
the elastic member includes a contact surface being in contact with the bottom surface of the recessed portion,
the bottom surface of the recessed portion is provided with a first groove through which the second flow path and the gap communicate,
the inner circumferential surface of the recessed portion is provided with a third groove that defines the gap, and
the first groove and the third groove are continuous.

10. The flow path member according to claim 1, wherein
the elastic member includes a contact surface being in contact with the bottom surface of the recessed portion,
the contact surface of the elastic member is provided with a second groove through which the second flow path and the gap communicate,
an outer circumferential surface of the elastic member is provided with a fourth groove that defines the gap, and
the second groove and the fourth groove are continuous.

11. The flow path member according to claim 9, wherein
the elastic member includes a contact surface being in contact with the bottom surface of the recessed portion,
the contact surface of the elastic member is provided with a second groove through which the second flow path and the gap communicate,
an outer circumferential surface of the elastic member is provided with a fourth groove that defines the gap, and
the second groove and the fourth groove are continuous.

12. The flow path member according to claim 1, wherein
the second seal portion is in contact with the coupling surface.

13. A flow path unit comprising:
the flow path member according to claim 1; and
the pipe coupled to the flow path member.

14. A liquid ejecting apparatus comprising:
a nozzle configured to eject a liquid;
the flow path member according to claim 1; and
the pipe coupled to the flow path member.

15. The liquid ejecting apparatus according to claim 14, further comprising:
a liquid reservoir storing the liquid;
a pressurizing mechanism that is disposed between the liquid reservoir and the flow path member and that pressurizes and supplies the liquid inside the liquid reservoir toward the nozzle;
a liquid storage chamber that is provided downstream of the second flow path and that communicates with the second flow path;
a pressure chamber provided downstream of the liquid storage chamber;
a communicating hole through which the liquid storage chamber and the pressure chamber communicate; and
a valve body that is inserted into the communicating hole and that blocks or opens the communicating hole, wherein
the valve body opens the communicating hole when a pressure inside the pressure chamber becomes less than or equal to a predetermined negative pressure.
